(19) United States
(12) Patent Application Publication
(10) Pub. No.: US 2006/0099943 A1
(43) Pub. Date: May 11, 2006

(54) Apparatus and method for receiving improved roaming service in a mobile terminal

(75) Inventor: In-Hoe Koo, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/222,907

(22) Filed: Sep. 9, 2005

(30) Foreign Application Priority Data
Nov. 11, 2004 (KR) 91728/2004

(51) Int. Cl. H04Q 7/20

(52) U.S. Cl. 455/432.1; 455/432.2

(57) ABSTRACT

An apparatus and method for receiving an improved roaming service in an MS are provided. Upon power-on of the MS, the MS stores information about PLMN cells that can be added as neighbor cells and determines whether a roaming service is required by checking frequency synchronization between the MS and a cell. If the roaming service is required, it is provided according to the PLMN information.

### PRIORITY

This application claims priority under 35 U.S.C. § 119 to an application entitled “Apparatus and Method for Receiving Improved Roaming Service in a Mobile Terminal” filed in the Korean Intellectual Property Office on Nov. 11, 2004 and assigned Serial No. 2004-91728, the contents of which are incorporated herein by reference.

### BACKGROUND OF THE INVENTION

1. Field of the Invention

The present invention relates generally to a mobile terminal, and in particular, to a roaming service-enabled mobile terminal.

2. Description of the Related Art

Typically, a cellular mobile communication system divides a service area into a plurality of service areas (cells) each being served by a separate base station (BS). The BSs are controlled by a mobile switching center (MSC) so that subscribers using mobile stations (MSs) can communicate while roaming between cells. To enable communication between the mobile stations and the cellular mobile communications system, each BS transmits its unique pilot signal and establishes a radio channel with a mobile station within a respective cell.

For establishing a radio channel and enabling communications between a user and a BS, the MS must subscribe to at least one of a plurality of public land mobile networks (PLMNs) which are distinguished from one another according to MSCs or service providers. Since the PLMNs are geographically distributed, it is likely that the mobile station will move out of the service area of a home PLMN (HPLMN) to which it has subscribed. In this case, communications are not available to the mobile station.

To avoid this non-communication situation, each PLMN provides a roaming service to a mobile station according to roaming agreements between cellular mobile communication systems to allow the mobile station to establish communication with a PLMN when the mobile station moves between BSs within different PLMNs, in an overlapped area between the service areas of the BSs, or in the service area of a visited PLMN (VPLMN). The VPLMN refers to a PLMN to which the mobile station has not subscribed but which can provide the roaming service according to the location of the mobile station. For example, if the mobile station moves from the service area of a BS within the coverage of a mobile communication service provider SKT to the service area of another BS within the coverage of another mobile communication service provider KTF, the KTF BS supports a call service for the mobile station, serving as a VPLMN. An international roaming service as well as a domestic roaming service can be supported according to roaming agreements between service providers.

FIG. 1 is a flowchart illustrating an operation for receiving a roaming service in a mobile station. The mobile station periodically determines whether it can acquire frequency synchronization to a cell within a HPLMN in step 100. For example, if the user has subscribed to the PLMN of SKT, the mobile station determines whether it can be frequency-synchronized to a cell within the coverage of the SKT PLMN. After the frequency synchronization, the mobile station is placed in an idle state, recognizing that it is now capable of conducting a call in step 102.

If the mobile terminal fails to acquire frequency synchronization with a cell of the home PLMN at a current location, the mobile station prepares to receive a roaming service, recognizing that it is in a non-communication state in step 104. In step 106, the mobile station receives all available signals. Among them, there may be a GSM (Global System for Mobile network) signal, a CDMA (Code Division Multiple Access) signal which can be used for frequency synchronization between a mobile station and a cell. If a predetermined number of such signals are received, the mobile station arranges the frequencies of the signals according to their received signal strengths in step 108.

In step 110, the mobile station selects the frequency of a PLMN with the highest priority level. The PLMN priority level is a predetermined roaming priority level for the mobile station. As the roaming service starts, the mobile station determines whether the roaming service is available in PLMNs, sequentially from the highest to lowest priority levels, and implements the roaming service to a cell of the highest- priority PLMN.

Upon selection of the identification information of the highest-priority PLMN in step 110, the mobile station selects the strongest frequency among the arranged frequencies in step 112. The mobile station determines whether it can be synchronized to the selected frequency in step 114. In other words, the mobile station determines whether the frequency of the strongest received signal can be used for the mobile station. If the frequency synchronization is possible, the mobile station compares the identification information of the selected PLMN with PLMN identification information of the selected frequency signal in step 115. If the PLMN frequency identification information is identical, the strengths of signals received from cells are equal to or greater than a predetermined threshold, a network does not deny access for the mobile station, and the current cell is not classified as an area in which the frequency synchronization is difficult for the mobile station, the mobile station updates its location to the current cell to which it is frequency-synchronized in step 116 and returns to step 102.

On the contrary, if the frequency synchronization is impossible in step 114, or if the frequency identification information is different in step 115, the mobile station determines whether the selected frequency is weakest among the arranged frequencies in step 118. If the frequency is not weakest, the mobile station selects the next frequency in strength in step 120. If the frequency is weakest in step 118, the mobile station determines whether the current selected PLMN identification information is that of a PLMN with the lowest priority level in step 122. If it is not the lowest-priority PLMN identification information, the mobile station selects the identification information of a PLMN with the following priority level in step 124 and returns to step 112.

Despite the frequency identification information of the lowest-priority PLMN, if the mobile station is not frequency-synchronized to a particular cell in step 114 through step 120, the mobile station delays the roaming service for a predetermined period of time in step 126. When the predetermined period of time expires, the mobile station repeats step 106 through step 122.

The above-described conventional roaming service method requires arranging all received signals according to their strengths, sequentially determining whether frequency synchronization is possible to each arranged signal frequency with respect to a roaming priority level and repeating the procedure if the frequency synchronization is not possible. Therefore, the roaming service takes a certain amount of time, placing the mobile station in a non-communication state as in step 104. Even if the mobile station is located in a PLMN supporting the roaming service immediately, the conventional roaming service method places the mobile station in the non-communication state for a certain amount of time. Also, despite the presence of a signal to which the mobile station can be frequency-synchronized, cell search for frequency synchronization is performed for each roaming priority level, thereby lengthening the time of the non-communication state.

### SUMMARY OF THE INVENTION

An object of the present invention is to substantially solve at least the above problems and/or disadvantages and to provide at least the advantages below. Accordingly, an object of the present invention is to provide an apparatus and method for minimizing a time period for which a call service is interrupted for a mobile station in a roaming service.

The above and other objects are achieved by providing an apparatus and method for receiving an improved roaming service in a mobile station (MS).

According to one aspect of the present invention, in an apparatus for receiving an improved roaming service in a roaming service-enabled MS, a received signal strength measurer measures the strengths of RF (radio frequency) signals received at the MS. A controller, upon power-on of the MS, collects information about at least one PLMN from the received signals, stores the PLMN information, adds a cell selected according to the PLMN information as a neighbor cell if frequency synchronization of the MS is lost, and performs a roaming service to the neighbor cell if the MS has lost the frequency synchronization. A memory includes a PLMN information storage for storing the PLMN information under the control of the controller.

According to another aspect of the present invention, in a method of receiving an improved roaming service in a roaming service-enabled MS, information about at least one PLMN supporting a roaming service for the MS is stored, it is determined whether frequency synchronization between the MS and a frequency-synchronized cell is lost, a cell selected according to the PLMN information is added as a neighbor cell if the frequency synchronization is lost, and a roaming service is performed to the neighbor cell immediately when the MS has lost the frequency synchronization.

### BRIEF DESCRIPTION OF THE DRAWINGS

The above and other objects, features and advantages of the present invention will become more apparent from the following detailed description when taken in conjunction with the accompanying drawings in which:

FIG. 1 is a flowchart illustrating a typical roaming service procedure in a mobile station;

FIG. 2 illustrates the configuration of a mobile communication system in which a mobile station operates according to an embodiment of the present invention;

FIG. 3 is a block diagram of the mobile station according to the embodiment of the present invention;

FIG. 4 is a flowchart illustrating an operation for storing PLMN information in the mobile station according to the embodiment of the present invention;

FIG. 5 is a flowchart illustrating an operation for receiving a roaming service in the mobile station according to the embodiment of the present invention;

FIG. 6 is a flowchart illustrating an operation for adding a cell as a neighbor cell according to PLMN information in the mobile station according to the embodiment of the present invention; and

FIG. 7 is a flowchart illustrating an operation for determining whether frequency synchronization is possible with respect to random PLMN (RPLMN) cells according to the embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

The present invention is intended to provide a roaming service method in which information about PLMNs supporting a roaming service for a mobile station is preliminarily stored in the mobile station and the most suitable PLMN cell is added as a neighbor cell according to the stored VPLMN information, to thereby enable the roaming service immediately in a non-communication state. While the non-communication state can take place due to various factors, losing frequency synchronization between the mobile station and a current synchronized cell is defined as the non-communication state in an embodiment of the present invention, for notational simplicity. Therefore, a communication state is the state where the mobile station, which has lost the frequency synchronization, reacquires the frequency synchronization and thus is capable of providing a call service to a user.

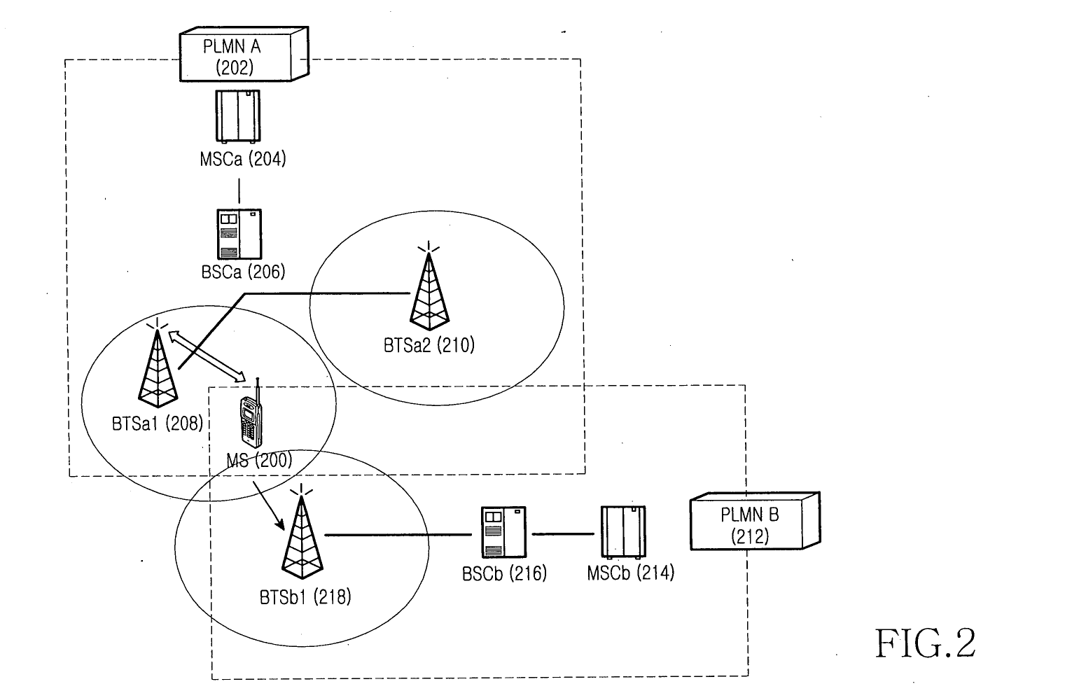

FIG. 2 illustrates the configuration of a mobile communication system in which a mobile station operates according to an embodiment of the present invention. The mobile communication systems includes PLMNs 202 and 212 (PLMN A and PLMN B, respectively) distinguished from each other by MSCs or service providers. The PLMNs 202 and 212 have MSCs 204 and 214 (MSCa and MSCb, respectively), a plurality of base station controllers (BSCs) 206 and 216 (BSCa and BSCb, respectively), a plurality of base transceiver stations (BTSs) 208, 210 and 218 (BTSa1, BTSa2 and BTSb1, respectively), and a mobile station (MS) 200.

The PLMNs 202 and 212 are managed by different service providers according to the embodiment of the present invention. They provide wireless services commonly in a specific area. The MSCs 204 and 214 provide a roaming service according to roaming agreements between the service providers. The PLMNs 202 and 212 are VPLMNs for the MS 200. It is assumed herein that the PLMN 202 is higher than the PLMN 212 in priority. The VPLMN refers to a PLMN other than a HPLMN, which can provide the roaming service to the MS.

The MSCs 204 and 214 are wired/wireless composite digital switching centers for providing wired communication functionality (PSTN/ISDN) and mobile communication functionality. The MSCs 204 and 214 are connected to a plurality of BSCs, provide basic and additional services, process incoming and outgoing calls for the MS 200 in conjunction with a legacy network or other networks, and perform location registration and handoff. The BSCs 206 and 216 are located between the MSCs 204 and 214 and the BTSs 208, 210 and 218 and manage and control the respective BTSs 208, 210 and 218. The BSCs 206 and 216 allocate or release radio channels to the MS 200, control transmit power between the MS 200 and the BTSs 208, 210 and 218, and perform a soft handoff between cells or determine whether to perform a hard handoff. The BSCs 206 and 216 also perform transcoding and vocoding, distribute global positioning system (GPS) clock signals for handoff and signal processing, and otherwise manage and maintain the BTSs 208, 210 and 218.

The BTSs 208, 210 and 218 are network end points connected to the BSCs 206 and 216. They are responsible for baseband signal processing, wired-wireless conversion and transmission/reception of radio signals to/from MSs. It is assumed that the BTSs 208 and 210 are connected to the BSC 206, and the BTS 218 to the BSC 216.

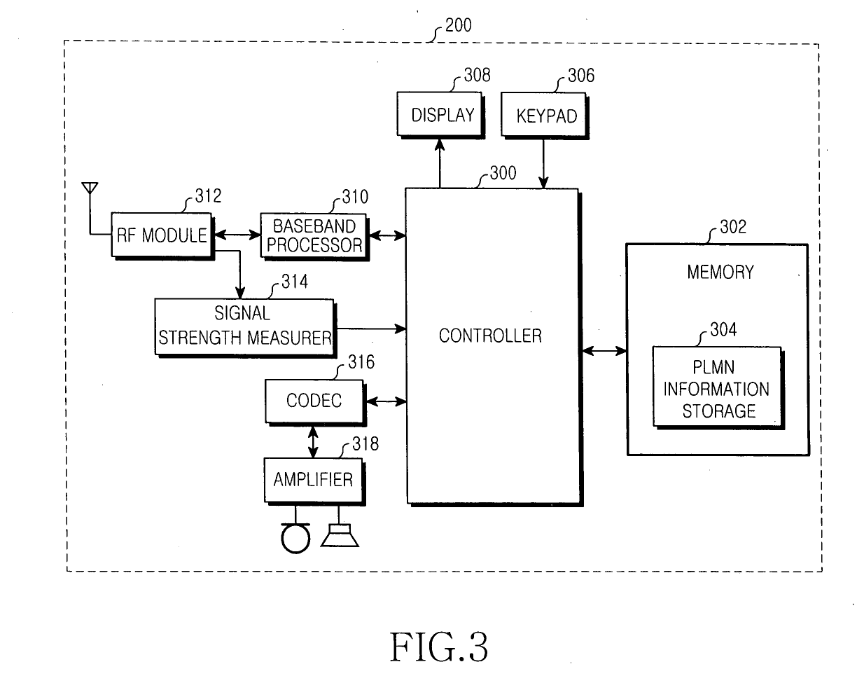

FIG. 3 is a block diagram of the MS 200 according to the embodiment of the present invention. The MS 200 includes a memory 302, a keypad 306, a display 308, a baseband processor 310, and a coder-decoder (CODEC) 316 which are connected to a controller 300. The controller 300 provides overall control to the MS 200 and processes voice signals and data according to protocols set for voice call, data communication, and wireless Internet connection. The controller 300 receives key input data corresponding to a key pressed by the user from the keypad 306 and controls the display 308 to display image information in correspondence with the key input data. According to the embodiment of the present invention, upon power-on of the MS 200, the controller 300 determines whether the MS 200 has been frequency-synchronized to HPLMN cells at the current location of the MS 200. If it has, the controller 300 measures the strengths of all received signals using an input from a signal strength measurer 314 and arranges the frequencies of the signals according to the signal strengths. The controller 300 filters away signals having strengths below a predetermined threshold and determines whether the MS 200 can be frequency-synchronized to the remaining signals having strengths equal to, or greater than, the threshold, sequentially. The frequencies of signals to which the MS 200 can be synchronized are stored as PLMN information. If the MS 200 approaches a non-communication state with respect to the current frequency-synchronized cell, the controller 300 selects the most suitable cell according to the stored PLMN information for a roaming service before the non-communication state.

The memory 302 connected to the controller 300 is provided with a PLMN information storage 304. The PLMN information storage 304 stores the PLMN information according to the embodiment of the present invention. The memory 302 includes a read only memory (ROM), a flash memory and/or a random access memory (RAM). The ROM stores programs for processing and controlling in the controller 300 and reference data. The RAM serves as a working memory for the controller 300 and stores updatable data. The keypad 306 includes alphanumerical keys and function keys and provides key input data from the user to the controller 300. The display 308 is generally provided with a liquid crystal display (LCD) and displays image information corresponding to received data (and other data) under the control of the controller 300.

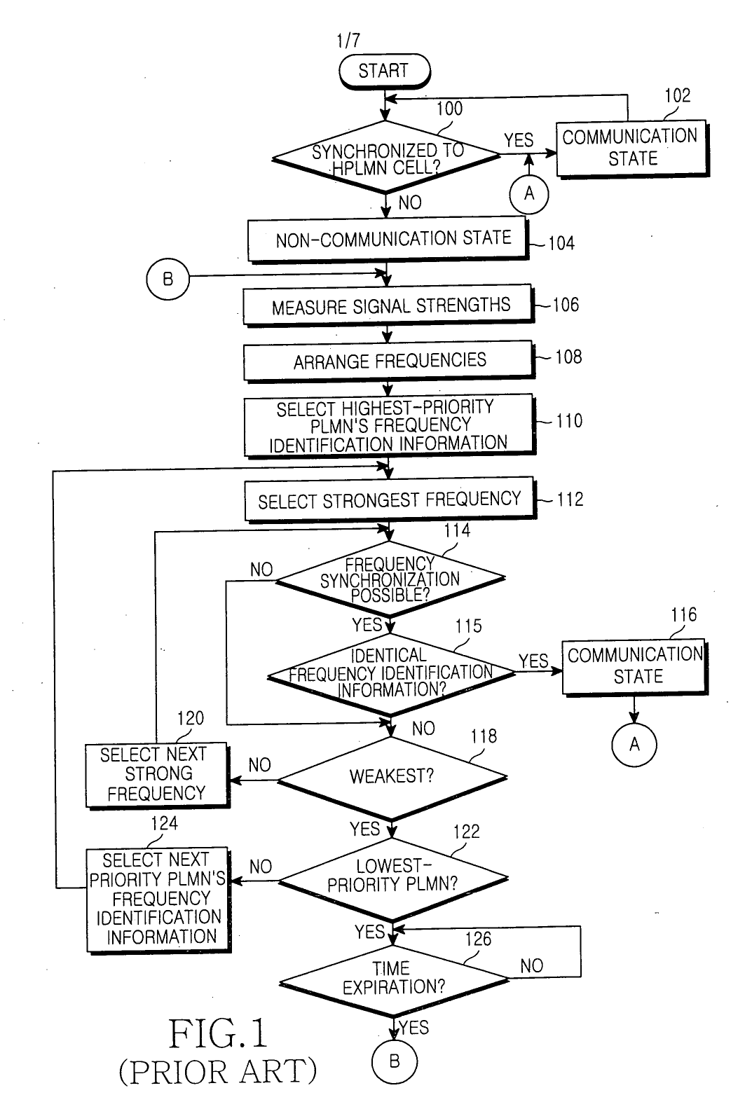

A radio frequency (RF) module 312 transmits/receives RF signals to/from the BTSs 208, 210 and 218 illustrated in FIG. 1. The RF module 312 converts a received RF signal to an intermediate frequency (IF) signal and outputs the IF signal to the baseband processor 310 connected to the controller 300. It also converts an IF signal received form the baseband processor 310 to an RF signal and transmits it over the air. The baseband processor 310 preferably includes a baseband analog ASIC (BBA) for interfacing between the controller 300 and the RF module 312. The baseband processor 310 converts a digital baseband signal received form the controller 300 to an analog IF signal and provides it to the RF module 312. It also converts an analog IF signal received from the RF module 312 to a digital baseband signal and provides the digital baseband signal to the controller 300. The CODEC 316 is connected to a microphone and a speaker via an amplifier 318. The CODEC 316 pulse code modulation (PCM)-encodes a voice signal received from the microphone and outputs coded voice data to the controller 300. It also PCM-decodes voice data received from the controller 300 and outputs the decoded voice signal to the speaker via the amplifier 318. The amplifier 318 amplifies the voice signals received from the microphone and the CODEC 316 with a speaker volume and a microphone gain adjusted under the control of the controller 300.

As the MS 200 moves further from the BTS 208 and closer to the BTS 218, the strength of a signal received from the BTS 208 weakens and the frequency-synchronization between the MS 200 and the BTS 208 commensurately weakens. Thus, the MS 200 approaches a non-communication state with the BTS 208 as it moves the service area of the BT 208. If the MS 200 has stored VPLMN frequency information, the MS 200 selects a frequency having the greatest signal strength of a VPLM with the highest priority level. It is assumed herein that the selected frequency is that the BTS 218 illustrated in FIG. 2. As the MS 200 moves closer to BTS 218 and further away from the BTS 208 (and thus becomes incapable of communication with the BTS 208), MS 200 synchronizes to the frequency of the neighbor cell BTS 218 and registers user information to the network. If the MS 200 attempts a call or an incoming call signal is received from the network, it can resume the call service immediately. Therefore, the MS 200 can minimize a time period for which the call service is interrupted in the roaming service.

Upon power-on of the MS 200, the controller 300 carries out location registration to register information about the MS 200 to the network. The location registration is the process of measuring the strengths of frequency signals received at the MS 200, arranging the frequencies according to the signal strengths, and searching for a cell to which the MS 200 is to be frequency-synchronized. By this procedure, the MS 200 searches for an HPLMN cell and acquires frequency synchronization to the HPLMN cell. After the location registration, the MS 200 is capable of communication. However, if the controller 300 detects VPLMN cells during searching for the HPLMN cell, it stores information about the VPLMN cells and their frequencies in the PLMN information storage 304. Even if the MS 200 is in a communication state, the controller 300 searches for available VPLMN cells, attempting synchronization to the frequencies of signals having strengths equal to, or greater than, a predetermined threshold.

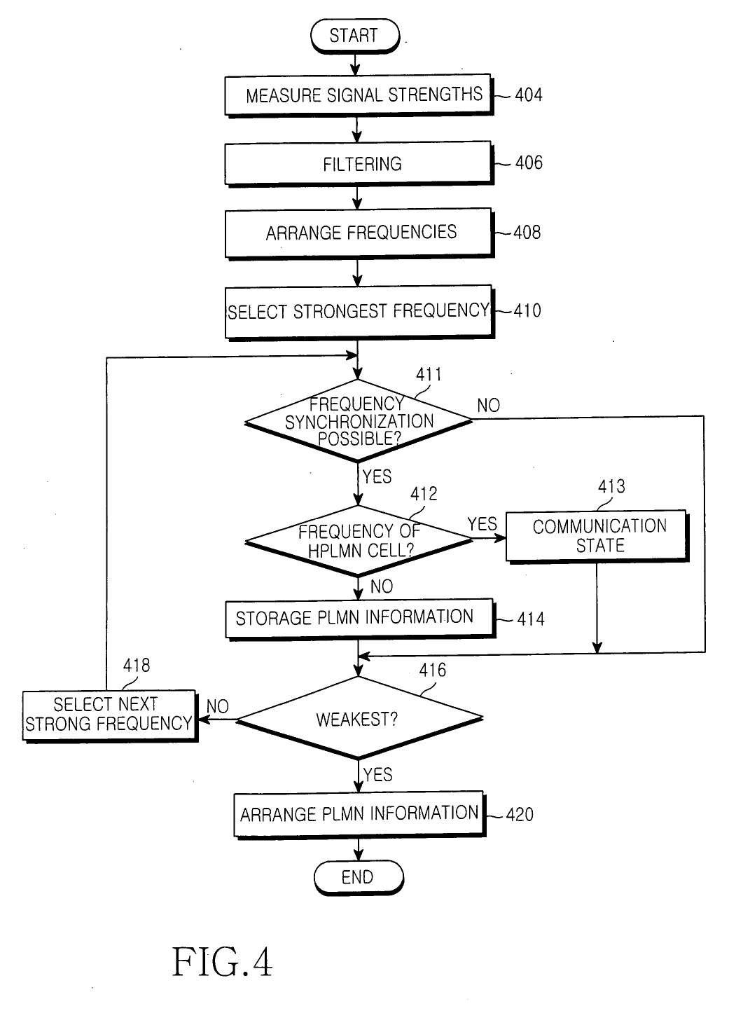

FIG. 4 is a flowchart illustrating an operation for storing PLMN information in the MS 200 according to the embodiment of the present invention. Upon power on of the MS 200, the controller 300 measures the strengths of signals received at the MS 200 in step 404 and filters away signals below a predetermined threshold in step 406. In step 408, the controller 300 arranges the remaining signals having strengths equal to, or greater than, the threshold according to their signal strengths. The controller 300 selects the strongest of the arranged frequencies in step 410 and determines whether the MS 200 can be synchronized to the selected PLMN frequency in step 411. If the frequency synchronization is not possible, the controller 300 jumps to step 416. On the other hand, if the frequency synchronization is possible, the controller 300 determines whether the selected PLMN frequency is that of a signal received from one of HPLMN cells in step 412. The determination can be made by checking frequency identification information included in the frequency signal.

In the case of an HPLMN frequency, the controller 300 synchronizes the MS 200 to the frequency, recognizing that the MS 200 is now in a communication state in step 413. If the MS 200 fails in frequency synchronization to any of the HPLMN cells, it is frequency-synchronized to the most suitable VPLM cell by the roaming service. In step 416, the controller 300 determines whether the frequency selected in step 410 is weakest among the arranged frequencies. On the other hand, if the frequency is not from a HPLMN cell in step 412, the controller 300 stores the frequency as PLMN information in the PLMN information storage 304 in step 414 and determines whether the frequency is weakest among the arranged frequencies in step 416.

If the frequency is not weakest, the controller 300 selects the following frequency in strength in step 418 and returns to step 411. On the contrary, if the frequency is weakest, the controller 300 discontinues storing further PLMN information and arranges PLMN information according to preset roaming priority levels by analyzing frequency identification information in the PLMN information. An example of PLMN information arrangement is shown below in Table 1.

TABLE 1

| VPLMN | | | RECEIVED SIGNAL |
|---|---|---|---|
| NUMBER | INDEX | FREQUENCY | STRENGTH |
| 1 | 1 | 0000 0000 0000 0001 | 1010 0100 |
| | 2 | 0000 0000 0000 0010 | 0100 1001 |
| | 3 | 0000 0000 0000 0011 | 0100 0010 |
| | . | | |
| | . | | |
| | . | | |
| | 31 | 0000 0000 0001 1110 | 0001 0110 |
| | 32 | 0000 0000 0001 1111 | 0001 0100 |
| . | | | |
| . | | | |
| . | | | |
| 10 | 1 | 1000 0000 0000 0001 | 1010 0100 |
| | 2 | 1000 0000 0000 0010 | 0100 1001 |
| | 3 | 1000 0000 0000 0011 | 0100 0010 |
| | . | | |
| | . | | |
| | . | | |
| | 31 | 1000 0000 0001 1110 | 0001 0110 |
| | 32 | 1000 0000 0001 1111 | 0001 0100 |

In Table 1, VPLMN Number indicates a VPLMN with a predetermined roaming priority level, which has frequencies to which the MS can be synchronized. PLMN information is arranged from the highest priority level to the lowest priority 10 level in Table 1. Among the frequencies arranged according to received signal strengths in step 408, frequencies to which the MS 200 can be synchronized are selected in step 411 and then arranged according to the roaming priority levels in step 420, as illustrated in Table 1. Therefore, Index 1 for VPLMN 1 indicates the strongest frequency in the highest-priority VPLMN. Each of the frequencies arranged with respect to each VPLMN number corresponds to one cell within the same VPLMN.

A plurality of pieces of PLMN information can be stored for each VPLMN as described with reference to FIG. 4. If 10 VPLMNs are preset, up to 10 pieces of such PLMN information (as illustrated in Table 1) can be stored in a PLMN field for each roaming priority level. As illustrated in Table 1, the PLMN field is an area for storing frequencies, received signal strengths, and indexes for each PLMN with a predetermined roaming priority level.

Table 1 shows 32 frequencies and received signal strengths in each PLMN field based on the BCCH (broadcast control channel (BCCH) allocation list field of S12 (where S12 is a type of system information) broadcast from a network. Yet, it is clearly to be understood that the number of frequencies and received signal strengths in each PLMN field varies when needed.

It may occur that a roaming service to a PLMN beyond predetermined priority levels is provided to an MS. For example, when a user uses his mobile station overseas, PLMN information associated with an overseas mobile communication service provider is not stored with any predetermined priority level in the mobile station. In accordance with the embodiment of the present invention, the MS must also store information about random PLMNs (RPLMNs) outside the predetermined priority levels. Thus, aside from PLMN fields of the PLMNs with the predetermined priority levels, the controller 300 stores information of RPLMNs about a predetermined number of or less RPLMNs.

Once the PLMN information is stored using the procedure described above and depicted in FIG. 4, the controller 300 periodically updates the PLMN information using the same procedure, for a VPLMN update, while being registered to the HPLMN. Upon detection of new VPLMN information, the controller 300 stores the VPLMN information in the PLMN information storage 304. Since frequencies set for the HPLMN cannot be those of a VPLMN, the controller 300 does not attempt frequency synchronization to the frequencies. Upon receipt of an incoming call signal from the network, the controller 300 terminates the procedure of FIG. 4 and immediately performs an incoming call-associated operation. The controller 300 also monitors the frequency synchronization to the current PLMN cell periodically and determines whether the roaming service is required. If the frequency synchronization is lost or falls below a predetermined level, a neighbor cell is added using the stored PLMN information, so that the roaming service can be provided by a neighboring cell immediately as the MS 200 enters into a non-communication state with a host cell.

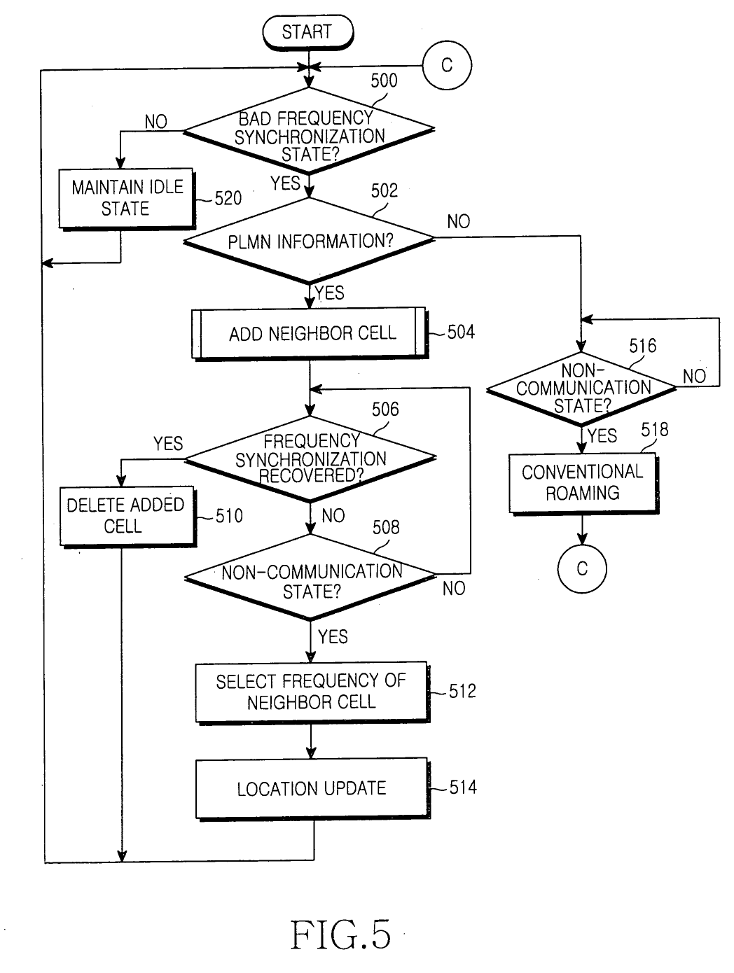

FIG. 5 is a flowchart illustrating an operation for receiving a roaming service in the MS according to the embodiment of the present invention. The controller 300 monitors the state of frequency synchronization to a current PLMN cell and determines whether the frequency synchronization is lost in step 500. The determination is made by checking whether the strength of a signal for frequency synchronization received from the cell has dropped so that it is equal to or less than a predetermined level (e.g. −100 dBm) or whether the number of neighbor cells supporting the roaming service is equal to or less than a predetermined value (e.g. 1).

In step 500, if the frequency synchronization is not lost, the controller 300 maintains an idle state in step 510 and returns to step 500. On the contrary, if the frequency synchronization is lost in step 500, the controller 300 determines whether there is stored PLMN information in step 502. In the absence of PLMN information, the controller 300 determines whether the MS 200 is now in a non-communication state in step 516. In the case of the non-communication state, the controller 300 performs a conventional roaming procedure in step 518.

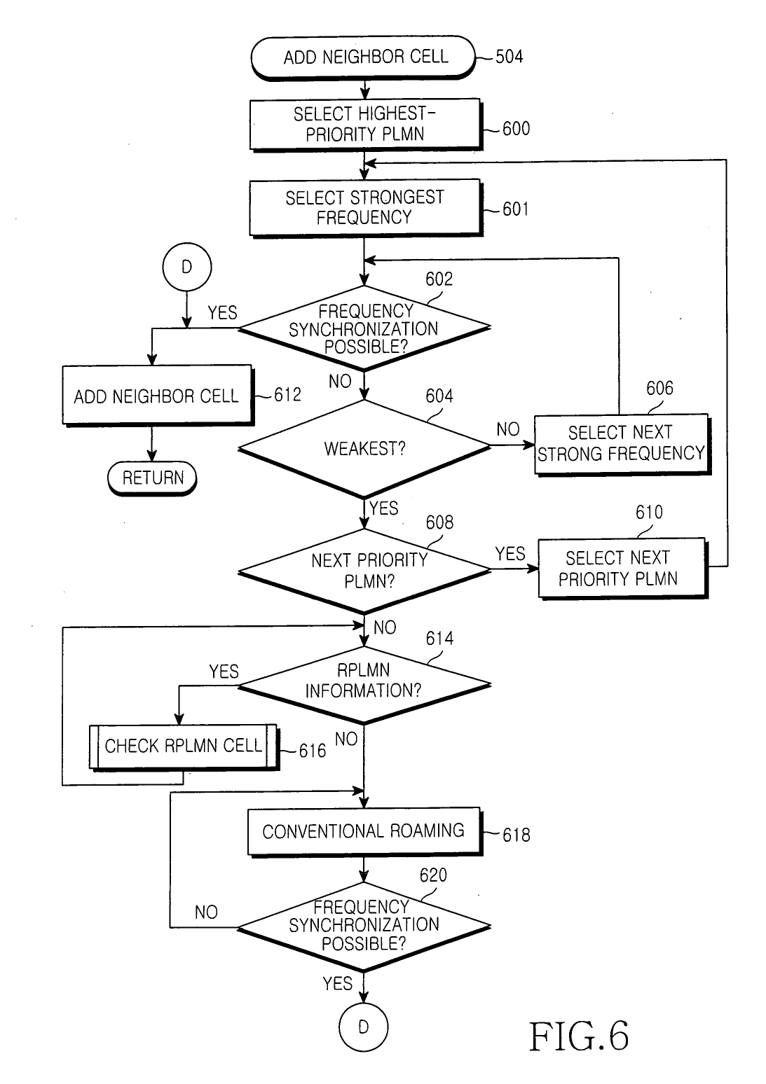

In the presence of PLMN information stored in the procedure of FIG. 4, the controller 300 adds the most suitable cell according to the PLMN information as a neighbor cell that can provide the roaming service to the MS 200 in step 504, which will be described later in great detail with reference to FIG. 6. In step 506, the controller 300 determines whether the frequency synchronization to the current cell has been recovered. The determination can be made by checking whether the strength of a signal received from the cell is equal to or greater than a predetermined level (e.g. −95 dBm), or the number of neighbor cells supporting the roaming service to the MS 200 is equal to or less than a predetermined (e.g., 3).

If the frequency synchronization has been recovered, the controller 300 deletes the added neighbor cell from a neighbor cell list in step 510. This is because the most suitable neighbor cell for the roaming service can be changed as the MS 200 roams. If the MS 300 moves to a new location, there may be a more suitable cell at the new location. Hence, if the frequency synchronization has been recovered in step 506, the neighbor cell added in step 502 is deleted in step 510, so that the most suitable neighbor cell is newly added when the frequency synchronization is again lost. Therefore a higher-priority PLMN is selected for the MS 200 if the MS 200 is in a VPLMN. The most suitable cell at the location of the MS 200 refers to a cell having the greatest signal strength in the highest-priority PLMN among cells to which frequency synchronization can be acquired.

If the frequency synchronization has not been recovered in step 506, the controller 300 determines whether the MS 200 is now in the non-communication state in step 508. In the case of a communication state, the controller 300 returns to step 506. In the case of the non-communication state, the controller 300 selects the frequency of the added neighbor cell in step 512. This implies that the MS 200 is synchronized to the frequency of the cell and thus receives the roaming service in the cell. In step 514, the controller 300 transmits information about the location of the MS 200 to the PLMN of the added neighbor cell so that the location information of the MS 200 is updated in the cell. The controller 300 then returns to step 500.

In this way, the MS 200 monitors the state of frequency synchronization to the current cell and (if the frequency synchronization is lost), adds the most suitable cell as a neighbor cell according to preliminarily stored PLMN information, so that the roaming service can be provided immediately in the non-communication state.

FIG. 6 is a flowchart illustrating an operation for adding a cell as a neighbor cell according to PLMN information in the MS according to the embodiment of the present invention. As the controller 300 begins step 504 in the procedure of FIG. 5, it selects the highest-priority PLMN set in the PLMN information storage 304 in step 600. In step 601, the controller 300 selects the strongest frequency in the PLMN information of the selected PLMN. The controller 300 determines whether the MS 200 can be synchronized to the selected frequency in step 602. If the frequency synchronization is possible, the controller 300 adds a cell having the selected frequency as a neighbor cell in which the MS 200 can receive the roaming service in step 612 and returns to step 506 in FIG. 5.

If the frequency synchronization is not possible in step 602, the controller 300 determines whether the selected frequency is weakest among the frequencies of the PLMN in step 604. Because the PLMN information is stored in the manner that arranges the frequencies of the PLMN in a descending order of signal strength, it is determined whether the selected frequency is the last in the list. If the frequency is not weakest, the controller 300 selects the following frequency in step 606. The following frequency is a frequency at the next index in terms of signal strength in the PLMN information stored for the PLMN. The controller 300 then returns to step 602.

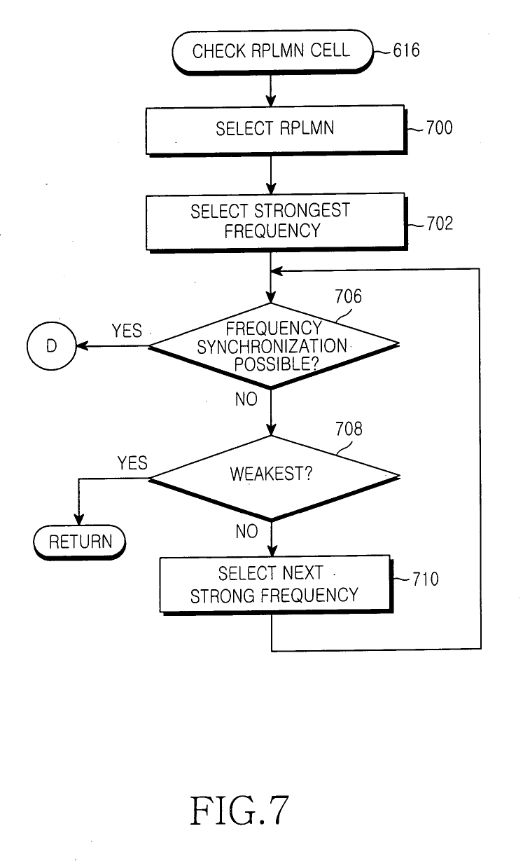

On the other hand, if the selected frequency is weakest in step 604, the controller 300 determines whether there exists a PLMN following the current PLMN in priority level in step 608. In the presence of the next-priority PLMN, the controller 300 selects this PLMN in step 610 and selects the strongest frequency in the PLMN information of the selected PLMN in step 600. In the absence of the next-priority PLMN, in other words, in the absence of PLMN information for the next-priority PLMN in the PLMN information storage 304, the controller 300 determines whether there is PLMN information of RPLMNs in step 614. In the presence of the RPLMN information in the PLMN information storage 304, the controller 300 selects one of RPLMNs set in the PLMN information storage 304 and determines whether frequency synchronization to a cell set in the PLMN information of the selected RPLMN can be acquired in step 616, which will be described later in more detail with reference to FIG. 7.

If the frequency synchronization is not possible in step 616, the controller 300 determines whether PLMN information exists for another RPLMN in step 614. In the presence of the RPLMN information, the controller 300 repeats step 616. In the absence of the RPLMN information, the controller 300 performs the conventional roaming procedure in step 618 and determines whether frequency synchronization is possible to a particular cell in step 620. If the MS 200 can be synchronized to the frequency of the cell in the roaming procedure, the controller 300 adds the cell as a neighbor cell in step 612. The controller 300 then determines whether the frequency synchronization to the current cell has been recovered in step 506 of FIG. 5.

FIG. 7 is a flowchart illustrating an operation for determining whether the MS 200 can be synchronized to a frequency set in the PLMN information of an RPLMN stored in step 420 of FIG. 4 in the case where the MS 200 receives a signal for frequency synchronization from the RPLMN. This procedure occurs in step 616 of FIG. 6.

As the controller 300 performs step 616, it selects one of RPLMNs set in the PLMN information storage 304 in step 700 and selects the strongest frequency in the PLMN information of the selected RPLMN in step 702. In step 706, the controller 300 determines whether frequency synchronization to the selected frequency can be acquired. If the frequency synchronization is possible, the controller 300 adds a cell corresponding to the frequency as a neighbor cell in step 612. On the contrary, if the frequency synchronization is not possible, the controller 300 determines whether the selected frequency is weakest among frequencies in the PLMN information of the RPLMN in step 708. If the frequency is not weakest, the controller 300 selects the next strong frequency in the PLMN information of the RPLMN in step 710 and returns to step 706. However, if the frequency is weakest in step 708, the controller 300 determines whether there is another RPLMN in step 614 of FIG. 6. The controller 300 then selects the RPLMN in step 616 or performs the conventional roaming procedure in step 618. In this way, even if none of cells corresponding to the PLMN information of PLMNs with predetermined priority levels are added as neighbor cells, the MS 200 can receive the roaming service from an RPLMN at the current location.

In accordance with the present invention as described above, upon power on of a MS, signals received at an MS are arranged according to their signal strengths, only signals available to the MS are extracted through filtering, the frequencies of the extracted signals are arranged according to predetermined roaming priority levels, and stored as PLMN information. The MS periodically updates the PLMN information of VPLMNs or an HPLMN, that is, frequencies and received signal strengths of the VPLMNs or the HPLMN, while measuring the strengths of received signals, arranging the frequencies of the signals according to the strengths, and searching for a cell to which the MS can be frequency-synchronized. If frequency synchronization to a current HPLMN cell is lost (e.g., it falls below −100 dBm), or if only one neighbor cell exists, the MS adds the most suitable cell as a neighbor cell according to the stored PLMN information. Thus, in a non-communication state, the MS can receive a roaming service immediately from the neighbor cell. Therefore, the time for which a call service is interrupted in the roaming service is remarkably reduced.

While the invention has been shown and described with reference to a certain preferred embodiment thereof, it is a mere exemplary application. For example, although 32 frequencies are stored as PLMN information for each PLMN in the PLMN information storage 304, the number of frequencies can be altered depending upon various circumstances. Also, while a predetermined number of pieces of PLMN information are stored in the procedure of FIG. 4, the criterion used for storing PLMN information can be a predetermined time and thus PLMN information obtained for the predetermined time is stored. Therefore, it will be understood by those skilled in the art that various changes in form and details may be made therein without departing from the spirit and scope of the invention as defined by the appended claims.

What is claimed is:

1. An apparatus for receiving an improved roaming service in a roaming service-enabled mobile station (MS), comprising:
a received signal strength measurer for measuring the strengths of radio frequency (RF) signals received at the MS;
a controller for, upon power-on of the MS, collecting information about at least one public land mobile network (PLMN) from the received signals, storing the PLMN information, adding a cell selected according to the PLMN information as a neighbor cell if frequency synchronization of the MS is lost, and performing a roaming service to the neighbor cell if the MS has lost the frequency synchronization; and
a memory including a PLMN information storage for storing the PLMN information under the control of the controller.

2. The apparatus of claim 1, wherein the controller passes signals having strengths being greater than or equal to a first predetermined level by filtering the received signals, and storing the frequencies of signals to which the MS can be synchronized among the passed signals as the PLMN information.

3. The apparatus of claim 1, wherein the controller arranges frequencies corresponding to cells within the at least one PLMN according to the strengths of signals for frequency synchronization received from the cells and stores the arranged frequencies as the PLMN information.

4. The apparatus of claim 1, wherein the controller classifies the PLMN information according to a priority level predetermined for the at least one PLMN and stores the classified PLMN information.

5. The apparatus of claim 4, wherein if the frequency synchronization is lost, the controller selects the PLMN information sequentially from the highest to lowest priority levels, selects cell information included in the selected PLMN information, attempts frequency synchronization to a cell corresponding to the cell information, and if the MS is synchronized to the frequency of the cell, adds the selected cell as a neighbor cell.

6. The apparatus of claim 5, wherein the controller selects cell information in a descending order of signal strength.

7. The apparatus of claim 1, wherein if the strength of a signal for frequency synchronization received from a frequency-synchronized cell is decreased so that it is equal to or less than a second predetermined level, the controller determines that the frequency synchronization is lost.

8. The apparatus of claim 7, wherein if the number of cells within the at least one PLMN is less than or equal to 3, the controller determines that the frequency synchronization is lost.

9. The apparatus of claim 1, wherein the PLMN information includes strengths of signals for frequency synchronization received from cells in the at least one PLMN, the frequencies of the signals, and identification information of the at least one PLMN.

10. A method of receiving an improved roaming service in a roaming service-enabled mobile station (MS), comprising the steps of:
storing information about at least one public land mobile network (PLMN) supporting a roaming service for an MS;
determining whether frequency synchronization between the MS and a frequency-synchronized cell is lost;
adding a cell selected according to the PLMN information as a neighbor cell if the frequency synchronization is lost; and
performing a roaming service to the neighbor cell immediately when the MS has lost the frequency synchronization.

11. The method of claim 10, wherein the PLMN information includes strengths of signals for frequency synchronization received from cells in the at least one PLMN, the frequencies of the signals, and identification information of the at least one PLMN.

12. The method of claim 10, wherein the PLMN information storing step comprises:
receiving signals at the MS;
arranging the frequencies of the received signals according to the strengths of the received signals;
passing frequencies to which the MS can be synchronized by filtering the arranged frequencies; and
classifying the passed frequencies according to predetermined roaming priority levels and storing the classified frequencies.

13. The method of claim 12, wherein the PLMN information storing step further comprises, storing the PLMN information for a random PLMN (RPLMN), if there is information about the RPLMN for which a roaming priority level is not predetermined.

14. The method of claim 12, wherein the arranging step comprises passing signals having strengths being equal to or greater than a first predetermined level by filtering the received signals.

15. The method of claim 12, wherein the PLMN information storing step further comprises storing a predetermined number of pieces of PLMN information.

16. The method of claim 12, wherein the PLMN information storing step further comprises storing PLMN information obtained for a predetermined time period.

17. The method of claim 10, wherein the determining step comprises determining the frequency synchronization is lost if the strength of a signal for frequency synchronization received from the frequency-synchronized cell is decreased so that it is equal to or less than a second predetermined level.

18. The method of claim 17, wherein the determining step further comprises determining that the frequency synchronization is lost if the number of neighbor cells is less than or equal to 3.

19. The method of claim 10, wherein the adding step comprises:
selecting a cell according to cell information included in the PLMN information;
determining whether frequency synchronization to the selected cell can be acquired; and
adding the cell as a neighbor cell according to the determination.

20. The method of claim 19, wherein the cell selecting step comprises:
selecting PLMN information of a PLMN with a highest roaming priority level;
determining whether the MS can acquire frequency synchronization to cells corresponding to the PLMN information, sequentially in a descending order of the strengths of signals for frequency synchronization received from the cells; and
selecting PLMN information of a PLMN with a second highest roaming priority level, if the MS does not acquire frequency synchronization to any of the cells.

21. The method of claim 20, wherein the step of selecting PLMN information of a PLMN with a second highest roaming priority level comprises, selecting PLMN information of a random PLMN (RPLMN) for which a roaming priority level is not predetermined, in the absence of the PLMN with the second highest roaming priority level or the PLMN information of the PLMN with the second highest roaming priority level.

22. The method of claim 21, wherein the RPLMN selecting step comprises:
selecting PLMN information of one of RPLMNs stored in the MS;
selecting PLMN information in the PLMN information of the RPLMN sequentially in a descending order of received signal strength;
determining whether the MS can be synchronized to frequencies in the selected PLMN information sequentially in descending order of received signal strength;
adding, a cell corresponding to the PLMN information as a neighbor cell, if there is PLMN information corresponding to a frequency to which the MS can be synchronized; and
selecting PLMN information of another RPLMN, if the MS can not be synchronized to frequencies corresponding to the PLMN information.

23. The method of claim 10, wherein the roaming service performing step comprises:
determining whether the frequency synchronization has been recovered between the MS and the frequency-synchronized cell;
determining whether the MS has lost the frequency synchronization, if the frequency synchronization has not been recovered;
performing the roaming service to the added neighbor cell, if the MS has lost the frequency synchronization; and
updating location information of the MS in a PLMN having the added neighbor cell.

24. The method of claim 23, wherein the frequency synchronization recovery determining step comprises determining that the frequency synchronization has been recovered if the strength of the signal for frequency synchronization received from the frequency-synchronized cell is increased to or above a predetermined level.

25. The method of claim 24, wherein the frequency synchronization recovery determining step further comprises the step of determining that the frequency synchronization has been recovered if the number of visited PLMNs (VPLMNs) supporting the roaming service is increased so that it is equal to or greater than a predetermined number.
